(19) United States
(12) Patent Application Publication
(10) Pub. No.: US 2025/0171272 A1
(43) Pub. Date: May 29, 2025

(54) ELEVATOR INSPECTION OPERATION SIGNALING SYSTEM

(71) Applicant: WURTEC, INCORPORATED, Toledo, OH (US)

(72) Inventors: Steven P. Wurth, Sylvania, OH (US); Terry Rodebaugh, Whitehouse, OH (US); Christopher D. Blessing, Toledo, OH (US); Christopher G. Watkins, Temperance, MI (US); Daniel R. Conrad, Liberty Center, OH (US)

(21) Appl. No.: 18/840,296

(22) PCT Filed: Feb. 23, 2023
(86) PCT No.: PCT/US2023/063137

§ 371 Date: Aug. 21, 2024

Related U.S. Application Data
(60) Provisional application No. 63/313,314, filed on Feb. 24, 2022.

(51) Int. Cl. B66B 5/00

(52) U.S. Cl. CPC B66B 5/005

(57) ABSTRACT

An elevator inspection operation signaling system configured to provide visual and/or audio indications of a moving elevator counterweight during operation of the elevator in an inspection operation mode is provided. The elevator inspection operation signaling system includes one or more signaling assemblies attached to an elevator counterweight. Each of the one or more signaling assemblies has visual and/or audio assemblies. A controller interface is in communication with the one or more signaling assemblies. One or more switches is in communication with the controller interface and is further configured to place the elevator in an inspection operation mode. Activation of the one or more switches causes activation of the visual and/or audio assemblies.

### RELATED APPLICATIONS

This application claims the benefit of U.S. Provisional Application No. 63/313,314 filed on Feb. 24, 2022. The entire disclosure of the above application is incorporated herein by reference in its entirety.

### FIELD

The present disclosure relates generally to vertical transportation systems, more particularly, to an elevator signaling system used to provide visual and/or audio indications of a moving elevator counterweight during operation of the elevator in an inspection operation mode.

### INTRODUCTION

This section provides background information related to the present disclosure which is not necessarily prior art.

An elevator is a form of vertical transportation equipment that efficiently moves people and/or goods between floors, levels and/or decks of a building, vessel or other structure. One type of elevator is called a traction elevator. Traction elevators use geared or gearless traction machines to drive suspension elements connected on one end to an elevator car and connected on the opposite end to a counterweight. The elevator car and the counterweight are located within a portion of the building referred to as a hoistway. The geared or gearless machines are driven by electric motors.

Typically, the elevator car moves in a vertical direction within opposing car guide rails and the counterweight move in an opposing vertical direction within opposing counterweight guide rails. Often, the placement of the car and counterweight guide rails are such that the elevator car and the counterweight can be in close proximity to each other.

In operation, the elevator can be used in normal operation mode and in an inspection operation mode. In the normal operation mode, the elevator travels in rated speed and responds to incoming calls and outgoing calls. In inspection operation mode, the elevator travels at reduced speeds and does not respond to incoming calls nor outgoing calls. During the inspection operation mode, as the elevator car and the counterweight move in opposite directions within the hoistway, at an approximate midpoint of the hoistway, the elevator car and the counterweight are positioned substantially adjacent to each other, albeit traveling in different vertical directions. In the event personnel are positioned atop the elevator car, those personnel can become startled as the elevator car and the counterweight cross in close proximity to each other and in opposite vertical directions.

It would be advantageous if elevators operating on an inspection mode could be made safer.

### SUMMARY

It should be appreciated that this Summary is provided to introduce a selection of concepts in a simplified form, the concepts being further described below in the Detailed Description. This Summary is not intended to identify key features or essential features of this disclosure, nor is it intended to limit the scope of the elevator inspection operation signaling system.

The above objects as well as other objects not specifically enumerated are achieved by an elevator inspection operation signaling system configured to provide visual and/or audio indications of a moving elevator counterweight during operation of the elevator in an inspection operation mode. The elevator inspection operation signaling system includes one or more signaling assemblies attached to an elevator counterweight. Each of the one or more signaling assemblies has visual and/or audio assemblies. A controller interface is in communication with the one or more signaling assemblies. One or more switches is in communication with the controller interface and is further configured to place the elevator in an inspection operation mode. Activation of the one or more switches causes activation of the visual and/or audio assemblies.

The above objects as well as other objects not specifically enumerated are also achieved by a method of operating an elevator inspection operation signaling system configured to provide visual and/or audio indications of a moving elevator counterweight during operation of the elevator in an inspection operation mode. The method includes the steps of attaching one or more signaling assemblies to an elevator counterweight, each of the one or more signaling assemblies having visual and/or audio assemblies, communicating with the one or more signaling assemblies with a controller interface and communicating with the controller interface with one or more switches configured to place the elevator in an inspection operation mode. The activation of the one or more switches causes activation of the visual and/or audio assemblies.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a perspective view of a conventional elevator.

FIG. 2 is a simplified, schematic front view in elevation, of a portion of a conventional elevator hoistway of FIG. 1, showing the elevator car and the counterweight in relative first positions in the elevator hoistway.

FIG. 3 is a simplified, schematic front view in elevation, of a portion of a conventional elevator hoistway of FIG. 1, showing the elevator car and the counterweight in relative second positions in the elevator hoistway.

FIG. 4 is a schematic view of a portion of the counterweight and machine room of the conventional elevator of FIG. 1, illustrating a novel counterweight inspection operation signaling system.

FIG. 5 is a perspective view of a portion of a counterweight guide rail of the conventional elevator hoistway of FIG. 1.

FIG. 6A is a perspective side view of an actuation assembly of the novel counterweight inspection operation signaling system of FIG. 4.

FIG. 6B is a perspective plan view of the actuation assembly of FIG. 6A.

FIG. 7 is a front perspective view of a first signaling assembly of the novel counterweight inspection operation signaling system of FIG. 4.

FIG. 8 is a rear perspective view of the first signaling assembly of FIG. 7.

FIG. 9 is a front perspective view of a second signaling assembly of the novel counterweight inspection operation signaling system of FIG. 4.

FIG. 10 is a rear perspective view of the second signaling assembly of FIG. 9.

FIG. 11 is a front perspective view of a controller interface of the novel counterweight inspection operation signaling system of FIG. 4.

FIG. 12 is a side view of the controller interface of FIG. 11.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

In accordance with embodiments of the present invention, an elevator inspection operation signaling system is provided. Generally, the elevator inspection operation signaling system is configured to provide visual and/or audio indications of a moving elevator counterweight during operation of the elevator in an inspection operation mode. The term “counterweight”, as used herein, is defined to mean any structure configured to balance a portion of the weight of the elevator car and rated capacity of the elevator car. It will be understood the term “guide rail”, as used herein, is defined to mean any structure forming a track for guiding an elevator car or counterweight. The term “normal operation mode”, as used herein is defined to mean an elevator car and a counterweight assembly travel at normal rated speeds and the elevator car responds to incoming calls from the building floors and outgoing calls from within the elevator car. The term “inspection operation mode”, as used herein, is defined to mean the elevator car and the counterweight assembly travel at reduced speeds and the elevator car does not respond to incoming calls from the building floors nor outgoing calls from within the elevator car.

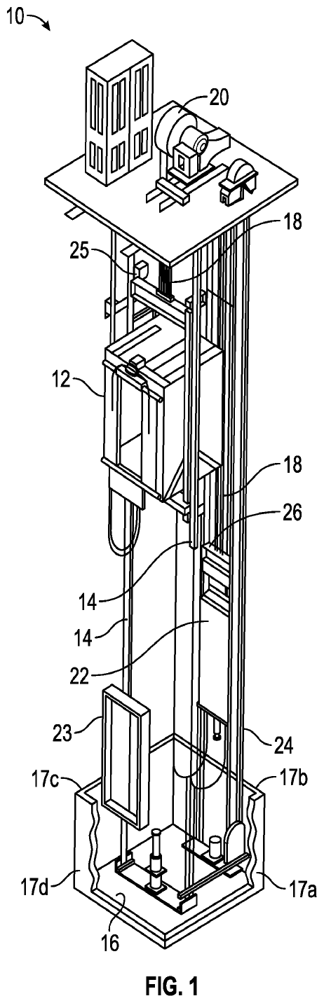

Referring now to the drawings, there is illustrated in FIG. 1 a diagrammatic and simplified view of system commonly known as an elevator 10. The elevator 10 is conventional in the art and will only be briefly described herein. The elevator 10 includes an elevator car 12, configured to move in a substantially vertical direction on opposing car guide rails 14. The opposing car guide rails 14 are disposed in a portion of a structure commonly known as an elevator hoistway or shaft 16. In the illustrated embodiment, the elevator hoistway 16 is defined by cooperating elevator hoistway walls 17a-17d. However, it should be appreciated that in other embodiments, the elevator hoistway 16 can be defined by other structures, assemblies and components, such as the non-limiting example of structural divider beams and the like. The elevator car 12 is supported at one end of one or more suspension ropes 18, which are moved with an elevator machine 20. The other end of the one or more suspension ropes 18 is connected to a counterweight assembly 22. The counterweight assembly 22 is configured to balance a portion of the weight of the elevator car 12 and the rated capacity of the elevator car 12. The counterweight assembly 22 moves in a substantially vertical direction on opposing counterweight guide rails 24.

Referring again to FIG. 1, the elevator car 12 includes a plurality of car guide members 25 configured to roll or slide against the car guide rails 14 as the elevator car 12 moves vertically within the elevator hoistway 16. In a similar manner, the counterweight assembly 22 includes a plurality of counterweight guide members 26 configured to roll or slide against the counterweight guide rails 24 as the counterweight assembly 22 moves vertically within the counterweight guide rails 24.

Referring again to FIG. 1, the elevator hoistway 16 is divided vertically into building floors (not shown). The building floors can have entrances 23 configured to facilitate ingress into and egress out of the elevator car 12.

Referring again to FIG. 1, in operation, the elevator 10 can be used in a normal operation mode and in an inspection operation mode. In the normal operation mode, the elevator car 12 and the counterweight assembly 22 travel in the normal rated speed and the elevator car 12 responds to incoming calls from the building floors and outgoing calls from within the elevator car 12. In inspection operation mode, the elevator car 12 and the counterweight assembly 22 travel at reduced speeds and the elevator car 12 does not respond to incoming calls from the building floors nor outgoing calls from within the elevator car 12.

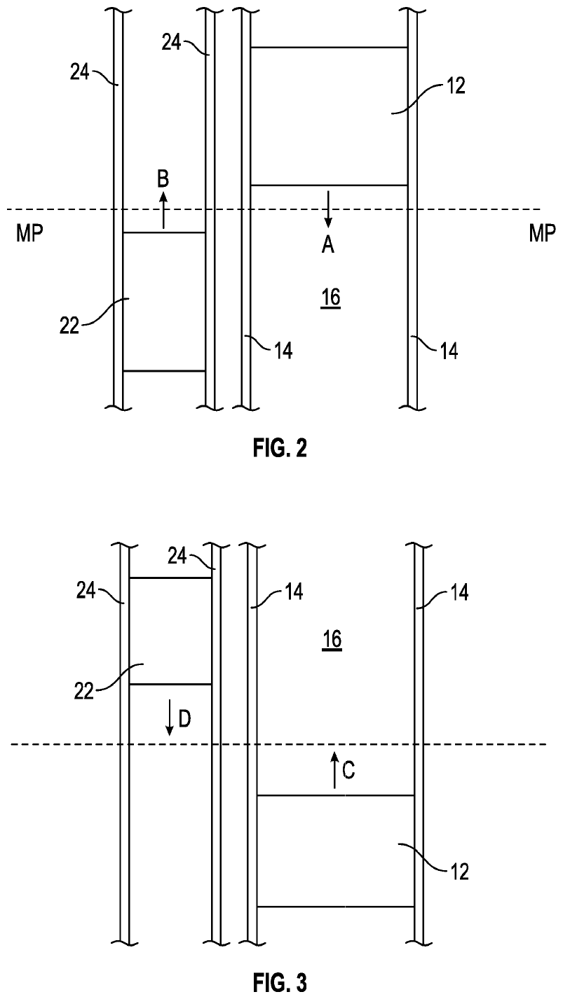

Referring now to FIG. 2, a simplified illustration of the elevator hoistway 16 of FIG. 1 is shown. The elevator car 12 is supported by the opposing elevator guide rails 14 and the counterweight assembly 22 is supported by the opposing counterweight guide rails 24. With the elevator car 12 positioned at an upper location within the hoistway 16, the counterweight assembly 22 is correspondingly positioned in a lower location within the elevator hoistway 16. With the elevator 10 in an inspection operation mode, as the elevator car 12 descends to lower levels of the hoistway 16, as shown by direction arrow A, the counterweight assembly 22 travels in the opposite vertical direction, thereby ascending as shown by direction arrow B. At an approximate midpoint of the elevator hoistway 16 as shown schematically by axis MP-MP, the elevator car 12 and the counterweight assembly 22 are positioned substantially adjacent to each other, albeit traveling slowly in different vertical directions. In the event personnel are positioned atop the elevator car 12, those personnel can become startled as the elevator car 12 and the counterweight assembly 22 cross in close proximity to each other while traveling in opposite vertical directions.

Referring now to FIG. 3, the elevator car 12, again supported by the opposing car guide rails 14, is positioned at a lower location within the elevator hoistway 16 and the counterweight assembly 22, supported by the counterweight guide rails 24, is correspondingly positioned in an upper location within the elevator hoistway 16. With the elevator in an inspection operation mode, as the elevator car 12 ascends to upper levels of the elevator hoistway 16, as shown by direction arrow C, the counterweight assembly 22 travels in the opposite vertical direction, thereby descending as shown by direction arrow D. As before, at an approximate midpoint of the hoistway 16 as shown schematically by axis MP-MP, the elevator car 12 and the counterweight assembly 22 are positioned adjacent to each other, albeit traveling slowly in different vertical directions. In the event personnel are positioned atop the elevator car 12, those personnel can become startled as the elevator car 12 and the counterweight assembly 22 cross in close proximity to each other while traveling in opposite vertical directions.

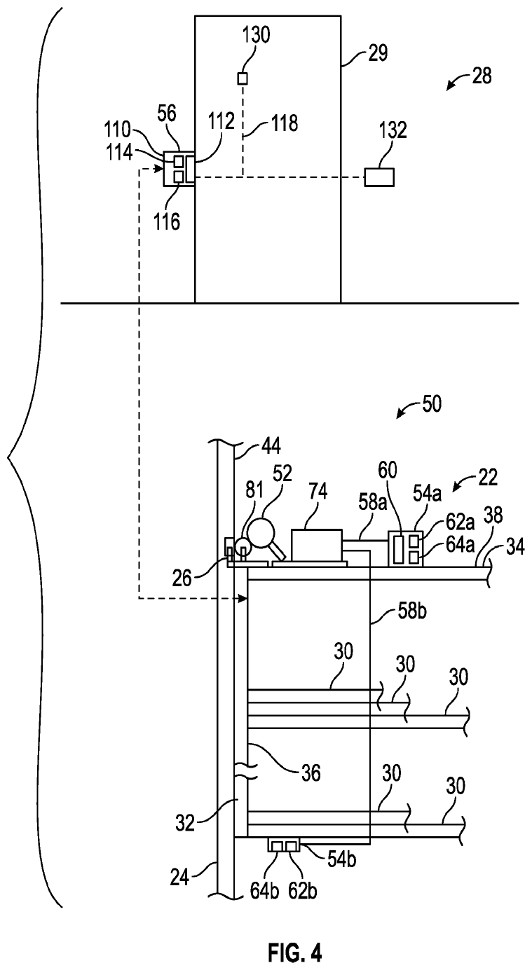

Referring now to FIG. 4, a simplified, schematic illustration of a portion of the elevator counterweight assembly 22, counterweight guide rail 24 and machine room 28 are shown. In the illustrated embodiment, an elevator controller 29 is positioned in the machine room 28. However, in other embodiments, the elevator controller 29 can be positioned in other locations, including the non-limiting example of the elevator hoistway 16 (FIG. 1). The counterweight assembly 22 is conventional in the art and will only be briefly described herein. The counterweight assembly 22 includes a plurality of counterweight filler weights 30 arranged in a stacked orientation and supported by opposing counterweight profiles 32 (for purposes of clarity, only a left side profile 32 is illustrated). The opposing counterweight profiles 32 are connected together at their upper ends by a cross member 34. Each of the opposing counterweight profiles 32 form inner major surfaces 36, extending in a substantially vertical orientation. The cross member 34 forms a substantially flat upper surface 38, extending from one counterweight profile 32 to the opposing counterweight profile.

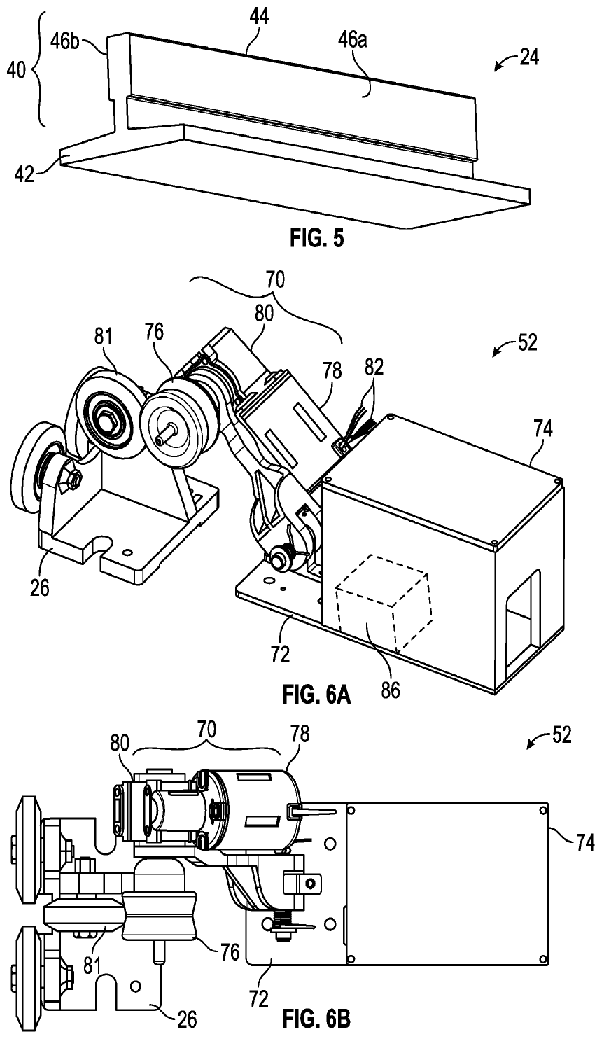

Referring now to FIGS. 4 and 5, the counterweight guide rail 24 is conventional in the art and will only be briefly described herein. The counterweight guide rail 24 has an inverted “T” cross-sectional shape and includes a flange 40 extending from a base 42. The flange 40 includes a front face 44 spanning opposing side faces 46a, 46b. The counterweight guide rail 24 will be discussed in more detail below.

Referring again to FIG. 4, the counterweight assembly 22 has been equipped with a novel elevator inspection operation signaling system 50 (hereafter “signaling system”). The signaling system 50 is configured to provide visual and/or audio indications of a moving elevator counterweight assembly 22 when the elevator 10 is in an inspection operational mode. The signaling system 50 includes components mounted to counterweight assembly 22 and additional components associated with the elevator controller 29. The components mounted to the counterweight assembly 22 include an actuation assembly 52, a first signaling assembly 54a and a second signaling assembly 54b. The components associated with the elevator controller 29 include a controller interface 56.

Referring now to FIGS. 4, 6A and 6B, the actuation assembly 52 is configured for several functions. First, the actuation assembly 52 is configured to generate electrical power as the counterweight assembly 22 moves in a vertical direction along the counterweight guide rails 24. The generated electrical power is conveyed to the first signaling assembly 54a by a first electrical connector 58a and to the second signaling assembly 54b by a second electrical connector 58b. The generated electrical power is used by the first signaling assembly 54a to power a first wireless transceiver 60, a first lighting assembly 62a and a first audio assembly 64a. The generated electrical power is used by the second signaling assembly 54b to power a second lighting assembly 62b and a second audio assembly 64b.

Optionally, it is contemplated that the actuation assembly 52 can be configured to generate signals indicating movement and the direction of movement by the counterweight assembly 22. The generated signals, indicating movement and the direction of the movement by the counterweight assembly 22 can be discrete signals, separate and apart from the electrical power generated by the counterweight assembly 22. However, it should be appreciated that in other embodiments, the generated movement and direction of movement signals are optional and are not required for successful operation of the novel signaling system 50.

Referring again to FIGS. 4, 6A and 6B, the actuation assembly 52 includes a generator assembly 70 pivotally mounted to a base 72 and a generator controller 74. The generator assembly 70 includes a rotatable generator wheel 76 coupled to a generator body 78 with a transmission assembly 80. In operation, the generator wheel 76 is configured to contact an outer surface of a roller guide 81 forming a portion of the counterweight guide member 26. The outer surface of the roller guide 81 is in contact with the front face 44 of the counterweight guide rail 24 and rotates as the counterweight assembly 22 moves along the counterweight guide rail 24. The rotation of the roller guide 81 in turn causes rotation of the generator wheel 76. The rotation of the generator wheel 76 is conveyed by the transmission assembly 80 to an armature (not shown for purposes of clarity) positioned within the generator body 78 and electrical power is generated as is known in the generator arts. The generated electrical power is conveyed to the generator controller 74 via electrical connectors 82.

While the embodiment illustrated in FIGS. 4, 6A and 6B shows the generator wheel 76 as being in contact with and driven by rotation of the roller guide 81, it is contemplated that in other embodiments, the generator wheel 76 can be driven with other structures, mechanisms and devices. As one non-limiting example, it is contemplated that the generator wheel 76 can be positioned to be in direct contact with the front face 44 of the counterweight guide rail 24 and rotate as the counterweight assembly 22 moves along the counterweight guide rail 24.

Referring again to FIGS. 4, 6A and 6B, the generator assembly 70, rotatable generator wheel 76, generator body 78 and the transmission assembly 80 can have any desired structure suitable for the functions provided herein. It should also be appreciated that the generator assembly 70, rotatable generator wheel 76, generator body 78 and the transmission assembly 80 can be configured to provide voltages and currents suitable for the functions described herein.

Referring again to FIGS. 4, 6A and 6B, the base 72 is configured to support the generator assembly 70, rotatable generator wheel 76, generator body 78 and the transmission assembly 80 and is further configured to attachment to the upper surface 38 of the cross member 34. In the illustrated embodiment, the base 72 is bolted to the upper surface 38 of the cross member 34. In other embodiments, the base 72 can be attached to the upper surface 38 of the cross member 34 with other structures, mechanisms and/or devices. In still other embodiments, the generator assembly 70, rotatable generator wheel 76, generator body 78, transmission assembly 80 and the generator controller 74 can be supported and attached to the elevator counterweight assembly 22 with other structures, mechanisms and devices, sufficient for the functions described herein.

Referring again to FIGS. 4. 6A and 6B, the generator controller 74 includes control circuitry that is in electrical communication with the generator assembly 70 via electrical connectors 82 and is configured for several functions. First, the generator controller 74 is configured to receive the electrical power generated by the generator assembly 70. Second, the generator controller 74 is further configured to convey the electrical power generated by the generator assembly 70 to the first and second signaling assembly 54a, 54b. Third, the generator controller 74 is in communication with a controller interface 56, positioned in the machine room 28 and proximate the elevator controller 29. Finally, the generator controller 74 is configured to actuate the first and second lighting assemblies 62a, 62b and the first and second audio assemblies 64a, 64b.

Referring now to FIG. 6A, the generator controller 74 further includes a power source, shown schematically at 86. The power source 86 is configured to power the first lighting assembly 62a and the first audio assembly in the event the elevator counterweight assembly 22 moves within the elevator hoistway 16 with the elevator 10 in an inspection operation mode. In the illustrated embodiment, the power source 86 is a rechargeable battery that is charged by the actuation assembly 52 as the counterweight assembly 22 moves during normal operation via the generator assembly 70 riding on the counterweight guide rail 24. However, the power source 86 can have other suitable forms and can be charged in other suitable manners.

Referring now to FIGS. 4, 7 and 8, the first signaling assembly 54a is illustrated. The first signaling assembly 54a includes a housing 84 having a major front surface 85a and a major rear surface 85b. The housing 84 is configured to enclose the first wireless transceiver, shown schematically at 60, the first lighting assembly 62a, the first audio assembly 64a and a power source, shown schematically at 86.

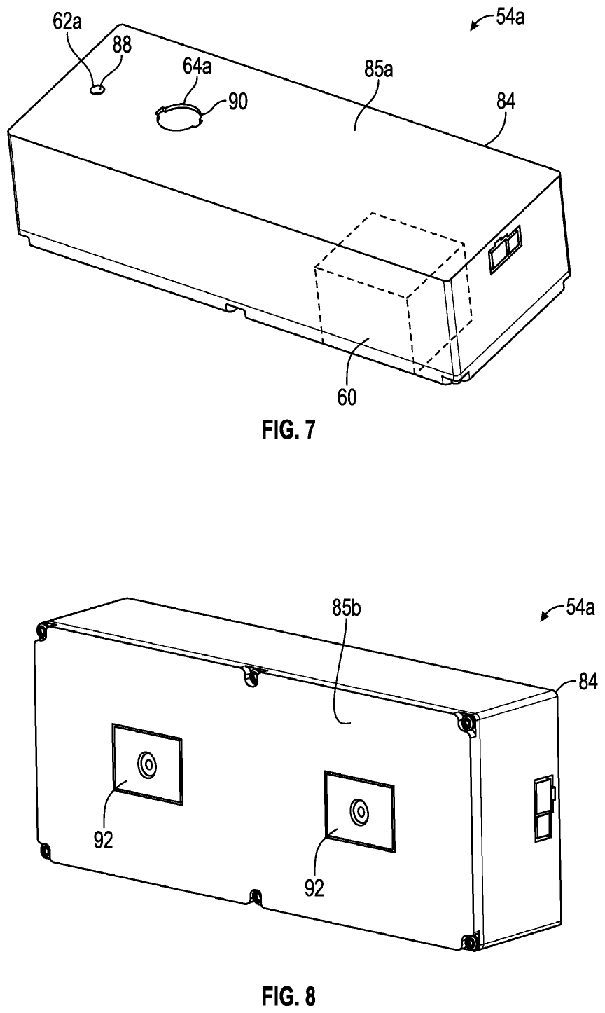

Referring now to FIGS. 4 and 7, the first wireless transceiver 60 is configured to transmit and receive radio waves. As will be described in more detail below, the first wireless transceiver 60 is further configured for wireless communication with a second wireless transceiver positioned proximate the elevator controller 29. While the signaling system 50 is described herein as utilizing wireless communication between the first and second signaling assemblies, it should be appreciated that in other embodiments, the first and second signaling assemblies can be configured for other forms of communication, including the non-limiting example of wired communication.

Referring again to FIGS. 4 and 7, the first lighting assembly 62a is in electrical communication with the generator controller 74. In the illustrated embodiment, the first lighting assembly 62a has the form of a flashing strobe-style of light that flashes through a first aperture 88 formed in the major front surface 85a of the housing 84. However, in other embodiments, the first lighting assembly 62a can have other forms and can provide other forms of visual indications, such as the non-limiting examples of flashing colored lights and interrupted beams of light formed by one or more lasers. In still other embodiments, any desired structure, mechanism or device can be used to provide the flashing strobe-style of light.

Referring again to FIGS. 4 and 7, the first audio assembly 64a is configured to provide continuous audio indications through a second aperture 90 in the major front surface 85a of the housing 84 as the elevator counterweight assembly 22 moves within the elevator hoistway with the elevator 10 in an inspection operation mode. In the illustrated embodiment, the first audio assembly 64a is configured to provide a beeping sound having any desired and suitable tone, pulse and volume. It should be appreciated that in other embodiments, any suitable structure, mechanism or device can be used to provide the audio indications.

Referring now to FIG. 8, a plurality of magnets 92 are connected to the major rear surface 85b of the housing 84. The plurality of magnets 92 are configured to attach the major rear surface 85b of the first signaling assembly 54a to the upper surface 38 of the cross member 34. Advantageously, the use of the magnets 92 facilitates removal of the first signaling system 54a and repositioning of the first signaling system 54a to another location without the use of tools. In other embodiments, it is contemplated that the first signaling assembly 54a can be mounted to other desired locations on the counterweight assembly 22 and other mounting methods can be used.

Referring now to FIGS. 4, 9 and 10, the second signaling assembly 54b is illustrated. The second signaling assembly 54b includes a housing 96 having a major front surface 98a and a major rear surface 98b. The housing 96 is configured to enclose the second lighting assembly 62b and the second audio assembly 64b.

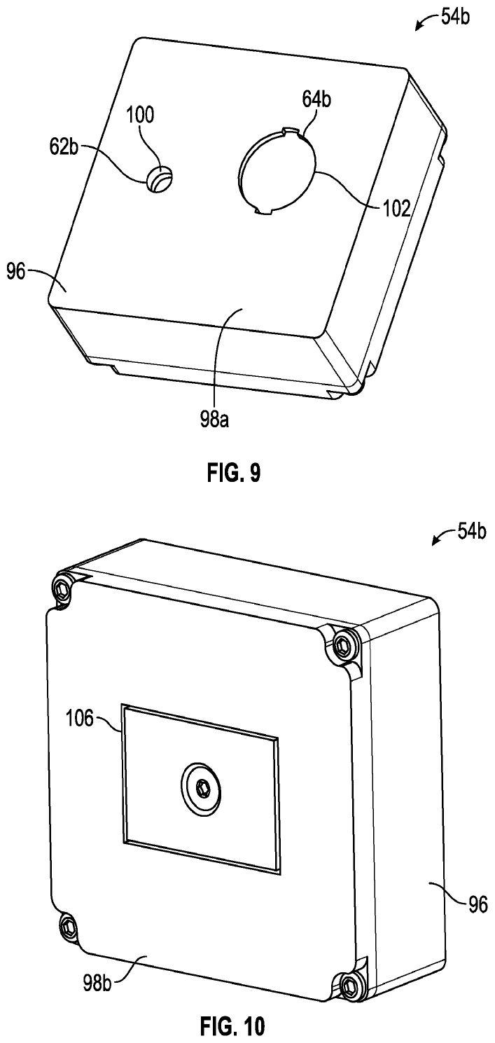

Referring now to FIGS. 4 and 9, the second lighting assembly 62b is in electrical communication with the generator controller 74 via the second electrical connector 58b. In the illustrated embodiment, the second lighting assembly 62b is the same as, or similar to, the first lighting assembly 62a shown in FIG. 7 and described above and is configured to flash through a first aperture 102 formed in the major front surface 98a of the housing 96. In alternate embodiments, it is contemplated that the second lighting assembly 62b can be different from the first lighting assembly 62a. It is further contemplated that the second lighting assembly 62b can have other forms and can provide other forms of visual indications, such as the non-limiting examples of flashing colored lights and interrupted beams of light formed by one or more lasers. In still other embodiments, any desired structure, mechanism or device can be used to provide the flashing strobe-style of light.

Referring again to the embodiment illustrated in FIGS. 4 and 9, the second audio assembly 64b is configured to provide continuous audio indications through a second aperture 102 in the major front surface 98a of the housing 96 as the elevator counterweight assembly 22 moves within the elevator hoistway with the elevator 10 in an inspection operation mode. In the illustrated embodiment, the second audio assembly 64b is the same as, or similar to, the first audio assembly 64a shown in FIG. 7 and described above. In alternate embodiments, it is contemplated that the second audio assembly 64b can be different from the first audio assembly 64a. In a manner similar to the first audio assembly 64a, the second audio assembly 64b is configured to provide a beeping sound having any desired and suitable tone, pulse and volume. It should be appreciated that in other embodiments, any suitable structure, mechanism or device can be used to provide the audio indications.

Referring now to FIGS. 4 and 10, one or more magnets 106 are connected to the major rear surface 98b of the housing 96. The one or more magnets 106 are configured to attach the major rear surface 98b to a counterweight filler weight 30. Advantageously, the use of the one or more magnets 106 facilitates removal of the second signaling system 54b and repositioning of the second signaling system 54b to another location without the use of tools. In the embodiment illustrated in FIG. 4, the major rear surface 98b of the second signaling system 54b is seated against a lower surface of a counterweight filler weight 30. In other embodiments, it is contemplated that the second signaling assembly 54b can be mounted to other desired locations on the counterweight assembly 22 and other mounting methods can be used.

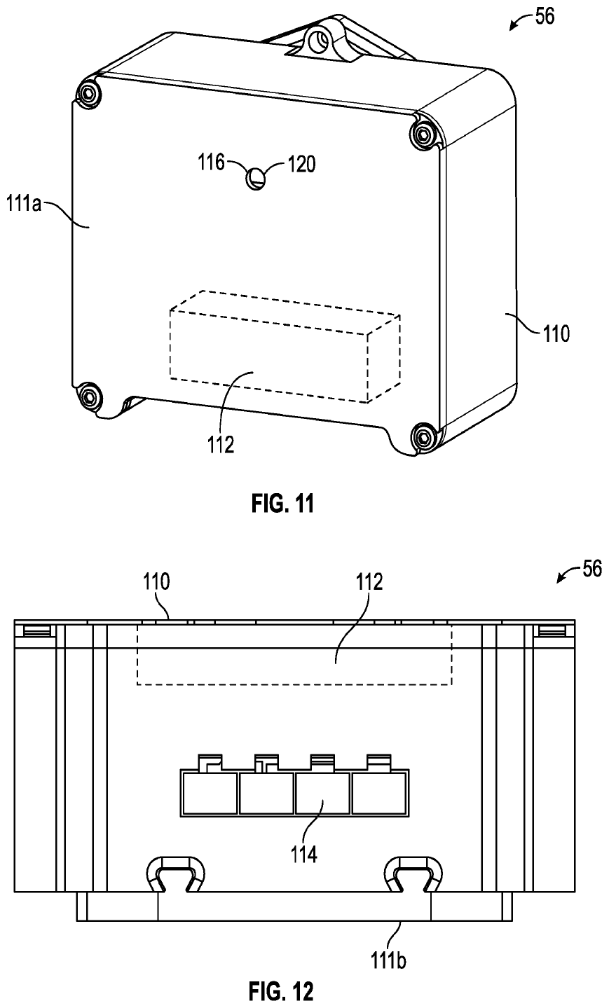

Referring now to FIGS. 4 and 11, the controller interface 56 includes a housing 110 having a major front surface 111a and a major rear surface 111b. The housing 110 is configured to enclose a second wireless transceiver, shown schematically at 112, a plurality of input terminals 114 and an indicator assembly 116.

Referring now to FIGS. 4 and 11, the second wireless transceiver 112 is configured to transmit and receive radio waves. As will be described in more detail below, the second wireless transceiver 112 is further configured for wireless communication with the first wireless transceiver 60 positioned within the first signaling assembly 54a and proximate the elevator counterweight assembly 22. In the embodiment illustrated in FIGS. 4 and 11, the second wireless transceiver 112 is the same as, or similar to, the first wireless transceiver 60 shown in FIGS. 4 and 7 and described above. In alternate embodiments, the second wireless transceiver 112 can be different than the first wireless transceiver 60.

Referring now to FIG. 12, the plurality of input terminals 114 is configured to electrically connect one or more inputs via electrical connectors (shown schematically at 118 in FIG. 4) from the elevator controller 29 with the second wireless transceiver 112. In the illustrated embodiment, the plurality of input terminals 114 has the form of multi-pole terminal block. However, in other embodiments, the input terminals 114 can have other forms sufficient to electrically connect one or more inputs via electrical connectors from the elevator controller 29 with the second wireless transceiver 112.

Referring again to FIGS. 4 and 11, the indicator assembly 116 is in electrical communication with the generator controller 74 and is configured to signal to a person in the machine room 28 that the first and second signaling systems 54a, 54b have sufficient power and are activated. In the illustrated embodiment, the indicator assembly 116 has the form of a flashing strobe-style of light that flashes through an aperture 120 formed in the major front surface 111a of the housing 110. However, in other embodiments, the indicator assembly 116 can have other forms and can provide other forms of visual indications, such as the non-limiting examples of flashing colored lights and interrupted beams of light formed by one or more lasers. In still other embodiments, any desired structure, mechanism or device can be used to provide the flashing strobe-style of light.

Referring now to FIG. 4, operation of the novel signaling system 50 will now be described. When the elevator 10 is placed in an inspection operation mode, from any location so equipped, including the non-limiting examples of an inspection operation switch 130 located proximate the elevator controller 29, an input terminal 132 located in the machine room 28, a switch in an elevator pit (not shown), or a cartop switch (not shown), the controller interface 56 at the elevator controller 29 will activate. Once activated, the controller interface 56 will communicate via wireless radio frequency signals to the first signaling assembly 54a mounted to the counterweight assembly 22. In the event the first signaling assembly 54a has sufficient power, the first signaling assembly 54a will communicate via corresponding wireless signals back to the controller interface 56 indicating activation.

Once the first signaling assembly 54a has been activated, the plurality of lighting assemblies 62a, 62b mounted at the bottom and top of the counterweight assembly 22 will strobe and the first and second audio assemblies 64a, 64b also mounted to the counterweight assembly 22, will sound anytime the counterweight assembly 22 moves throughout the hoistway 16. Once the elevator 10 is removed from inspection operation mode, the first and second signaling assemblies 54a, 54b will no longer produce audible and visual signals to indicate movement.

Referring again to FIG. 4., optionally the novel signaling system 50 can be equipped with a variety of sensors configured to provide operational feedback to the controller 29. It is contemplated that the optional sensors can detect and provide information concerning the proximity of the counterweight assembly 22 to the elevator car 12, displacement of the counterweight assembly 22 from the counterweight guide rails 24 as in the event of an earthquake, slackening of the suspension ropes 18 supporting the counterweight assembly 22 and operational statistics, such as the non-limiting examples of trip count, speed, acceleration and the like.

While the embodiment of the novel signaling system 50 described above and illustrated in FIG. 4 shows the application of the signaling system 50 to the counterweight assembly 22, it is within the contemplation of the invention that the signaling system 50 can be applied to other structures configured to move within the building hoistway, such as the non-limiting examples of construction platforms, car slings and/or moving skips. In this manner, the signaling system 50 can be configured to provide notice to others located in or about the hoistway of a moving structure.

The embodiment of the counterweight signaling system 50 described above and illustrated in FIG. 4 makes use of a generator assembly 70 in rolling contact with a counterweight guide rail 24. It should be evident that the counterweight guide rail 24 is sufficiently rigid that the generator assembly 70 can be pressed against it with sufficient pressure to actuate the first signaling system 54a. However, it is further contemplated that the signaling system 50 could be used in applications that do not utilize a counterweight guide rail 24. As one non-limiting example, it is contemplated that the signaling system 50 could be adapted such that the generator assembly 70 is in rolling contact with a wall, building members or other structures providing sufficient rigidity to enable the generator assembly 70 to actuate the first signaling system 54a. Such adaption of the signaling system 50 would enable application to other embodiments using vertically moving structures, such as, for example window washing platforms, vertically movable scaffolding, traveling ladders and the like.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. An elevator inspection operation signaling system configured to provide visual and/or audio indications of a moving elevator counterweight during operation of the elevator in an inspection operation mode, the elevator inspection operation signaling system comprising:
one or more signaling assemblies attached to an elevator counterweight, each of the one or more signaling assemblies having visual and/or audio assemblies;
a controller interface in communication with the one or more signaling assemblies; and
one or more switches in communication with the controller interface and configured to place the elevator in an inspection operation mode;
wherein activation of the one or more switches causes activation of the visual and/or audio assemblies.

2. The elevator inspection operation signaling system of claim 1, wherein activation of the visual and/or audio assemblies is caused by either up or down movement of the elevator counterweight.

3. The elevator inspection operation signaling system of claim 1, wherein an actuation assembly is attached to the elevator counterweight and configured to generate electrical power for the one or more signaling assemblies.

4. The elevator inspection operation signaling system of claim 3, wherein the actuation assembly includes a generator assembly configured to be driven by a roller guide riding on a portion of a counterweight guide rail.

5. The elevator inspection operation signaling system of claim 4, wherein at least one of the one or more signaling assemblies includes a power source charged by the generator assembly.

6. The elevator inspection operation signaling system of claim 1, wherein at least one of the one or more signaling assemblies includes a first wireless transceiver.

7. The elevator inspection operation signaling system of claim 6, wherein the first wireless transceiver is configured to communicate with a second wireless transceiver located proximate an elevator controller.

8. The elevator inspection operation signaling system of claim 1, wherein at least one of the signaling assemblies is detachably attached to a counterweight profile of the counterweight with a plurality of magnets.

9. The elevator inspection operation signaling system of claim 1, wherein the visual assemblies have the form of a flashing strobe-style of light.

10. The elevator inspection operation signaling system of claim 1, wherein the audio assemblies have the form of a beeping sound.

11. A method of operating an elevator inspection operation signaling system configured to provide visual and/or audio indications of a moving elevator counterweight during operation of the elevator in an inspection operation mode, the method comprising the steps of:
attaching one or more signaling assemblies to an elevator counterweight, each of the one or more signaling assemblies having visual and/or audio assemblies;
communicating with the one or more signaling assemblies with a controller interface; and
communicating with the controller interface with one or more switches configured to place the elevator in an inspection operation mode;
wherein activation of the one or more switches causes activation of the visual and/or audio assemblies.

12. The method of claim 11, including the step of activating the visual and/or audio assemblies with either up or down movement of the elevator counterweight.

13. The method of claim 11, including the step of generating electrical power for the one or more signaling assemblies with an actuation assembly attached to the elevator counterweight.

14. The method claim 13, including the step of positioning a generator assembly to be driven by a roller guide riding on a portion of a counterweight guide rail to generate the electrical power.

15. The method of claim 14, including the step of charging a power source included in the one or more signaling assemblies with the generator assembly.

16. The method of claim 11, including the step of including a first wireless transceiver in the at least one of the one or more signaling assemblies.

17. The method of claim 16, including the step of communicating with the first wireless transceiver with a second wireless transceiver located proximate an elevator controller.

18. The method of claim 11, including the step of detachably attaching at least one of the signaling assemblies to a counterweight profile of the counterweight with a plurality of magnets.

19. The method of claim 11, wherein the visual assemblies have the form of a flashing strobe-style of light.

20. The method of claim 11, wherein the audio assemblies have the form of a beeping sound.
